(19) United States
(12) Patent Application Publication
(10) Pub. No.: US 2020/0141531 A1
(43) Pub. Date: May 7, 2020

(54) Thermal Insulation Body Having A Protective Layer

(71) Applicant: Porextherm Dämmstoffe GmbH, Kempten (DE)

(72) Inventors: Andreas Rell, Haldenwang (DE); Hans-Frieder Eberhardt, Glengen/Brenz Burgberg (DE); Richard Müller, Immenstadt (DE)

(21) Appl. No.: 16/625,214

(22) PCT Filed: Jun. 20, 2018
(86) PCT No.: PCT/EP2018/066463

§ 371 Date: Dec. 20, 2019

(30) Foreign Application Priority Data
Jun. 21, 2017 (DE) 10 2017 113 782.3

(51) Int. Cl. F16L 59/065; E04B 1/80

(52) U.S. Cl. CPC F16L 59/065; C09D 175/02; E04B 1/803

(57) ABSTRACT

The invention relates to a thermal insulation moulded body (1) comprising a thermal insulation layer (2) made of one or more insulation materials (3) and a cover layer (4), characterized in that the cover layer (4) is formed by a polyurea, obtained from a polyaddition-polymerisation reaction of an aromatic or aliphatic isocyanate and an OH-group-free polyamine with a terminal amine group, wherein the cover layer (4) is arranged on the thermal insulation layer (2) or the thermal insulation moulded body (1).

The present invention relates to a thermal insulation body having a protective layer.

Thermal insulation bodies can be found in many areas of technology such as, for example, in high-performance insulation bodies in the fields of aviation and astronautics, in the motor vehicle industry, in fuel cells, in temperature-controlled packaging, in industry in general as well as in the building industry. They are commonly employed where low weight, small space requirements and high-performance thermal insulation with very steep temperature gradients are of the essence. Said thermal insulation bodies are also marketed as vacuum insulated panels (VIP), the insulating properties of which are many times over and above those of conventional insulation materials and easily achieve thermal conductivity values of 5 mW/(mK) and less.

Thermal insulation bodies of this kind may easily have a temperature resistance of up to 1100° C. and are thus suitable for use as backup insulation in the steel, aluminum and gas industries. The (high-performance) molded thermal insulation bodies can have complex shapes to be able to provide efficient thermal insulation in tight spaces and under the most difficult conditions.

VIP as well as thermal insulation bodies are provided with a thermal insulation layer that contains an insulation material, for example highly dispersive, microporous silica and in the instance of VIP also an aerogel, open-cell foams made from minerals or in the form of organic rigid foams or an insulation material made from fibers. Besides said insulation materials, the various thermal insulation bodies are usually provided with further additives, in particular IR opacifiers, moisture scavengers and fiber filaments to support the three-dimensional structure when using highly dispersive silica.

Except for VIP, the thermal insulation bodies, or their thermal insulation layers respectively, may be machined relatively easily with commercially available tools and machines, in particular drilling, sawing, milling or cutting, wherein a dust extraction system should be present due to the dustiness of the thermal insulation material pyrogenic silica. The reason for the strong tendency to dust emission lies substantially in the fact that the often-used pyrogenic silica has a primary particle size of 5 to 50 nm and therefore acts almost like a gas and is respirable. Even the aggregated silica particles still have a size of 100 nm to 100 μm. The surfaces of thermal insulation layers made from pyrogenic silica are to be classified as rather delicate due to their chemical and physical properties. Similar considerations apply for the thermal insulation layers made from the other previously stated materials with the exception of fibers.

It has been the aim for a long time to protect the surfaces of thermal insulation layers and molded thermal insulation bodies, also known as including VIP, which by necessity have to have an enveloping layer since they would otherwise be unable to retain their vacuum.

Thus, a whole range of multi-layer sheaths for protecting said thermal insulation bodies or thermal insulation layers, are known from prior art; nonwoven fiber mat bags are used in particular for VIP; these in turn are inserted into metallized films, metal film sheaths or metal sheaths, and the seams are subsequently sealed or welded and may be folded over and fixed to the main surfaces of the thermal insulation body if necessary. If sheaths of this kind are not practical, the insulation material, which is also highly porous, must be protected from abrasion and mechanical damage in other ways, in particular from ingress of water, which destroys the pore structure.

From the prior art it is known to pour bitumen mixed with fibers as a casting material over microporous thermal insulation layers. However, bitumen is highly viscous and thus difficult to handle. Also, the bitumen penetrates the thermal insulation material to a significant degree, in particular more than one millimeter, which leads to significantly diminished insulating properties.

It is known from DE 20 2007 013 688 U1 to provide thermal insulation bodies with a sheath of pressed foam, rolled foam, extruded foam or a fiber material, in particular with a sheath made from plastic materials or fiber reinforced glass (FRG) based on polyester resin or PA, wherein adhesives based on water glass, silica sol or the like are used if necessary.

DE 103 08 581 A1 describes a microporous insulation layer made from precipitated or pyrogenic silica and sheathed in a watertight film made of a PU elastomer for VIP underwater insulation bodies.

Known from the field of protective and sealing coatings for pools, tanks, façades, floors, roads etc. are hot-spray coatings or coatings made from polyurea, which are also used as abrasion-resistant coatings in industry and in the building trade. They have a tensile strength of up to 23 N/mm² and elasticity according to DIN 53504 of up to 330%.

It is the objective of the invention to provide a thermal insulation body that comprises a thermal insulation layer that is at least partially enclosed by a cover layer.

Said objective is met by a molded thermal insulation body that comprises a thermal insulation layer made from one or more insulation materials, wherein the insulation material is made from a single material or from a blend of materials selected from a group formed by pyrogenic silica, precipitated silica, open-cell mineral foams, open-cell organic rigid foams, closed-cell inorganic foams, aerogels, polyurethane aerogel, mineral fibers, fiber composites, hollow glass spheres, vermiculite, xerogel, and a cover layer, in that the cover layer is formed by a polyurea, derived from a polyaddition polymerization reaction of an aromatic or aliphatic isocyanate and an OH group-free polyamine with terminal amino group, wherein the cover layer is disposed on the thermal insulation layer or on the molded thermal insulation body.

A molded thermal insulation body according to the invention is initially not limited in its spatial form according to the invention; it may therefore be provided in strip or sheet form or curved to cover pipes and other spatially curved bodies. The type of area of its surface is also initially not limited; thus it may have a triangular, quadrangular, pentagonal or polygonal shape, or may have any rounded shape—beginning with circular, elliptic, oval or undefined round shape. In any case, it is a molded body made from one or more of the said materials as used in the fields of technology stated at the outset, also in the form of VIP. The thermal insulation layer, as defined by the invention, is the actual thermally insulation material layer, which comprises at least one insulation material, in particular a highly dispersive, microporous thermal insulation material, preferably pyrogenic or precipitated silica. Other highly dispersive metal oxides may, according to the invention, also be present, as well as further substances.

In the simplest case, the thermal insulation body according to the invention is the thermal insulation layer itself. However, the molded thermal insulation body usually consists of a thermal insulation layer covered by a single layer or multi-layer sheath, wherein the molded thermal insulation body may comprise other items, in particular sheaths or penetrations such as eyelets or the like, as well as additional moldings for, for example, assembly purposes. It is also possible that such a thermal insulation body with sheath according to the invention is evacuated and thus constitutes a VIP.

With particularly great advantage, the invention now proposes to provide the molded thermal insulation body or the thermal insulation layer with a cover layer, which is directly or indirectly disposed on said thermal insulation body or thermal insulation layer and is made from a polyurea. Polyureas are elastomers derived from a reaction of an aromatic or aliphatic, monomeric, polymeric, quasi-polymeric or a prepolymeric isocyanate by step-growth polymerization with a polyamine having terminal amino group(s) without OH groups in the structure. Accordingly, this is therefore not a polyurethane (PUR or PU), which may be derived from a diisocyanate and a diol. Such two-component systems of aliphatic amines and isocyanates usually react very quickly due to the great nucleophilicity of the amines, which means, rather disadvantageously, that they have to be processed by two-component mixing machines, with pot life in the order of seconds. As already described, polyurea has good to very good chemical resistance as well as high elasticity and tear resistance. Said high elasticity and tear resistance as well as the associated self-healing power in case of tears, cuts or punctures has, surprisingly, a great advantage particularly with molded thermal insulation bodies, which are either produced in the form of a VIP or are installed around pipes or other solid bodies and are preferably covered in-situ with said cover layer. Such molded thermal insulation bodies are surprisingly just firm enough to bring the advantages of the cover layer material to the fore: during curing they will be pulled together/pressed together and thus pressed tightly against the body to be insulated so that the insulation is particularly effective. If said molded thermal insulation bodies were to be more rigid, for example concrete or steel components, said contracting effect of the cover layer would be futile; if they were significantly softer, they would be deformed by the cover layer to an unacceptable degree. Particularly the VIP will be and are under a pressure of 1 bar due to their evacuation and are correspondingly stiff. Moreover, this property of the polyurea, used according to the invention as cover layer, has the effect that a cover layer made from that material may also be applied uniformly onto all such bodies, the chemical and physical properties of which make such a direct coating more difficult or, depending on the material of the body, require different cover layers. The main reason for this is that said cover layer according to the invention tightens, as it were, on its own around the body, resulting in a durable cover layer. Thus, the polyurea cover layer known from other fields of technology proves to be surprisingly well suited for the application according to the invention, not least because of its impermeability to steam, which is significant in this area.

According to the invention the insulation material used in the thermal insulation body is made from a single material or from a blend of materials selected from a group formed by pyrogenic silica, precipitated silica, open-cell mineral foams, open-cell organic rigid foams, closed-cell inorganic foams, aerogels, polyurethane aerogel, mineral fibers, fiber composites, hollow glass spheres, vermiculite, xerogel. Silica is preferred in this instance. Silica is, however, particularly difficult to coat, since an insufficiently viscous cover layer material destroys the structure of the silica in that it penetrates too deeply, and a more viscous cover layer material is difficult to apply.

According to the invention said cover layer is not made to be connected chemically or generally firmly bonded to the thermal insulation layer or to the molded thermal insulation body, but rather, it adheres due to physical interactions so that special coatings, bonding agent layers or the like between the cover layer and the thermal insulation layer or the molded thermal insulation body are superfluous. This is of great advantage since it allows simple in-situ application of the cover layer onto a molded thermal insulation body at its installation site, for example a recently insulated pipeline. In its uncured state the cover layer is applied warm, in particular painted, brushed or sprayed on, and cures in-situ very quickly. This simple application method makes it possible to provide a cover layer irrespective of whether a sheathed VIP, a sheathed or unsheathed molded thermal insulation body or a sheathed or unsheathed thermal insulation layer itself is to be coated with a cover layer. It is also in accordance with the invention that a molded thermal insulation body is already coated with said cover layer ex-factory.

In further development of the invention it is provided that the cover layer fully envelopes the thermal insulation layer. It is in accordance with the invention that initially a cover layer is present on those parts of the molded thermal insulation body that are exposed to an environment of mechanical stresses during application. In other words the cover layer may, according to the invention, be provided on only one surface of the molded thermal insulation body or on parts of one of its surfaces, or on a number of its sides or parts of a number of its sides or, of course, on all sides. Incomplete coverage of a side may be intended if only part of this side is to be protected.

If the cover layer is provided with a uniform or variable layer thickness of between 0.1 mm and 5 mm, it is particularly suitable to provide a long useful life for the molded thermal insulation body in very rough application environments. Uniform layer thicknesses on the molded thermal insulation body are preferred, at least on each side of a molded thermal insulation body in any case, although it is possible, according to the invention, for the sides that are less heavily stressed to be provided with a lower layer thickness than the more stressed sides. Particularly preferred are layer thicknesses between 1 mm and 3 mm, including borders.

According to the invention it is of particularly great advantage if the cover layer is disposed directly on the thermal insulation layer. Such a direct application, that is, without interposing further coatings or material layers, is particularly simple from a manufacturing point of view. Surprisingly, the cover layer stretches around the body, particularly in instances where it extends over edges, and thus compresses said body at least a little. The same behavior occurs with VIP, although in this instance the cover layer according to the invention is inevitably not disposed directly on the thermal insulation layer since a VIP is provided with at least one sheath to retain the vacuum.

An alternative to that is, according to the invention, that a material layer is disposed between the cover layer and the thermal insulation layer, in particular a net-like material layer and/or a film. This design also includes the VIP where the cover layer is applied directly onto the sheath, exactly as with the thermal insulation bodies which have no such sheath. The material layer may be a fiberglass layer, a fiber mat or fabric, in particular also a blend of those, wherein the materials of the material layer are in particular inorganic materials according to the invention. It may also be a film or a layered combination of the two. It would also be according to the invention if a primer layer is disposed as a material layer between thermal insulation body and cover layer.

Furthermore, provision is made for the cover layer to contain at least one flame-retarding component. According to the invention this is provided through commonly used flame retardants.

In a manufacturing method according to the invention for the molded thermal insulation body described, the cover layer is applied in uncured form—in particular as a 2K mixture—in-situ onto the molded thermal insulation body, installed in its final operating position, in particular brushed, squirted or sprayed and cured in-situ, wherein the application, in particular of an uncured cover layer, takes place at a higher temperature, in particular at approximately 80° C. Said high temperature leads to a very short reaction time and thus to almost instantaneous curing and thus to a cover layer according to the invention which presses the molded thermal insulation body together strongly and therefore onto the insulated body. Said increased temperature is preferably achieved through the exothermicity of the curing reaction of the two components, but according to the invention it may also be achieved through external heating if the exothermic reaction is insufficient.

A ratio of approximately 1:1 between the amine component and the curing component is preferred for the 2K mixture according to the invention.

Also included in this manufacturing method according to the invention is a variation in which a nonwoven glass fabric or a fiber mat or a film is placed around the molded thermal insulation body or parts thereof and onto which the uncured cover layer is then applied. The first two of the above-named layers are advantageously able to capture any gas that leaks from the insulation material, which would otherwise impair the homogeneity and thus the effect of the cover layer due to the formation of blisters. The last of the named layers is used in particular with VIP since it prevents air ingress.

In a further manufacturing method according to the invention, the molded thermal insulation bodies according to the invention are already produced in the factory where, besides spraying the molded thermal insulation body to be coated with a cover layer, they may also be immersed in a heated, uncured cover layer fluid. In this instance also curing takes place at elevated temperatures, in particular between 70° C. and 80° C. The application takes place such that the surface of the insulation layer and thus the insulation material is not mechanically disturbed; in particular slow application is used according to the invention so as to avoid air inclusions that would impair the insulating effect. It is preferable to apply the uncured cover layer by spraying, since this makes it possible to mix the two reactants in a targeted manner immediately prior to its application in order to allow for the short pot life.

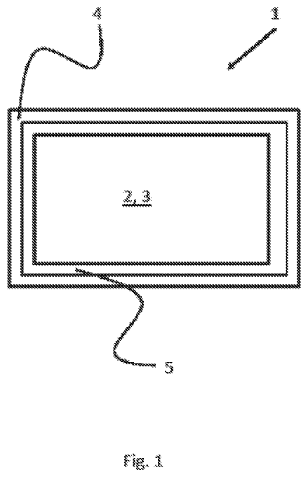

FIG. 1 depicts a schematic representation of a molded thermal insulation body 1 according to the invention. It is provided internally with a thermal insulation layer 2 made from a thermal insulation material 3, for example a body made from precipitated or pyrogenic silica. Arranged all around the said thermal insulation layer is a material layer 5, which in this example completely covers the entire surface of the thermal insulation layer 2. Arrangement on only one side of the thermal insulation layer 2 is also in accordance with the invention, but it must extend beyond the edges since only in this manner is it possible to achieve the mechanical anchoring of the cover layer 4 according to the invention. In the instance of said partial covering of the thermal insulation layer 2 the cover layer is preferably formed such that it envelopes one of the main surfaces and all narrow sides to ensure that it is optimally anchored. Accordingly, a coating that does not cover all sides is also one in which the cover layer material is present on all sides of the thermal insulation body, but not to the extent where one side is covered completely by the cover layer material. These embodiments apply directly to rectangular molded thermal insulation bodies, but equally also to those with other shapes. Not shown are common additions such as passage openings, anchoring means, folding seams or the like.

Surprisingly, the described invention combines the physical and chemical properties of a polyurea layer with those of molded thermal insulation bodies, whether they are evacuated or not, or whether they are enveloped or consist of one thermal insulation layer made from one insulation material only, so that a plurality of differently designed molded thermal insulation bodies can be made more robust mechanically and at the same time also more useful since they contract the material to which they are is applied, bringing the advantage of the polyurea, having just the right stiffness, to the fore. Thus, molded thermal insulation bodies are applicable for pipe insulation as well as for insulating coverings for motor vehicle loading surfaces and for mechanically protected internal walls of thermal insulating containers.

### LIST OF REFERENCE NUMERALS

1 Molded thermal insulation body
2 Thermal insulation layer
3 Insulation material
4 Cover layer
5 Material layer

1. A molded thermal insulation body (1) comprising a thermal insulation layer (2) made from one or more insulation materials (3) and a cover layer (4), wherein the insulation material (3) is made from a single material or from a blend of materials selected from a group formed by pyrogenic silica, precipitated silica, open-cell mineral foams, open-cell organic rigid foams, closed-cell inorganic foams, aerogels, polyurethane aerogel, mineral fibers, fiber composites, hollow glass spheres, vermiculite, xerogel, characterized in that the cover layer (4) is formed by a polyurea, derived from a polyaddition polymerization reaction of an aromatic or aliphatic isocyanate and an OH group-free polyamine with terminal amino group, wherein the cover layer (4) is disposed on the thermal insulation layer (2) or on the molded thermal insulation body (1).

2. The thermal insulation body (1) according to claim 1, characterized in that the cover layer (4) envelopes the thermal insulation layer (2) or the molded thermal insulation body (1) on all sides.

3. The thermal insulation body (1) according to claim 1, characterized in that the cover layer (4) has a uniform or variable layer thickness between 0.1 mm and 5 mm.

4. The thermal insulation body (1) according to claim 1, characterized in that the cover layer (4) is disposed directly on the thermal insulation layer (2).

5. The thermal insulation body (1) according to claim 1, characterized in that a material layer (5), is disposed between cover layer (4) and thermal insulation layer (2).

6. (canceled)

7. The thermal insulation body (1) according to claim 1, characterized in that the cover layer (4) comprises at least one flame-retarding component.

8. The thermal insulation body (1) according to claim 1, characterized in that the cover layer (4) has a uniform or variable layer thickness between 1 mm and 3 mm.

9. The thermal insulation body (1) according to claim 5, wherein the material layer (5) is a mesh-like material layer (5) and/or a film.

10. The thermal insulation body (1) according to claim 9, characterized in that the mesh-like material layer (5) is a woven fabric, a knitted fabric or a fiber mat or a mixture thereof.

11. The thermal insulation body (1) according to claim 9, characterized in that the mesh-like material layer (5) comprises a glass fiber material.
